(19) United States
(12) Patent Application Publication
(10) Pub. No.: US 2011/0306467 A1
(43) Pub. Date: Dec. 15, 2011

(54) ELECTROMAGNETIC LOAD DEVICE FOR AN APPARATUS FOR PHYSICAL EXERCISE, AND APPARATUS PROVIDED WITH SAID DEVICE

(76) Inventor: Enrico Massa, Quartu Sant'Elena (IT)

(21) Appl. No.: 12/998,377

(22) PCT Filed: Oct. 12, 2009
(86) PCT No.: PCT/IB2009/054469

§ 371 Date: Aug. 26, 2011

(30) Foreign Application Priority Data
Oct. 13, 2008 (IT) MI2008A001810

(51) Int. Cl. A63B 21/005; H02P 6/08; H02P 9/04; H02K 41/02

(52) U.S. Cl. 482/5; 310/12.04; 318/135; 290/7

(57) ABSTRACT

A load device for an apparatus for physical exercise that comprises a device that generate the load called linear motor, a micro controller, a series of sensors (dynamic, diagnostic and physiological) and a user interface.

### FIELD OF THE INVENTION

The present invention refers to an electromagnetic load device for an apparatus for physical exercise, and to an apparatus provided with said device.

### STATE OF THE ART

In the last years there has been a renewed interest towards a regular and systematic physical exercise with the aim to promote the health of a person, to increase physical qualities like strength and resistance and to reach a determined physical shape.

Many people, professionals and not, spend lots of time using these apparatus, in particular professional athletes that compete to reach the best possible results. As it is known, in the field of fitness machines, several configurations of apparatus exist, each one able to train the desired muscles of the athlete following suitable schemes.

Many of these machines utilize ballasts or weights to reach a sufficient load for the programmed muscles training.

Said weights are typically formed by disks or parallelepipeds of high specific weight (cast-iron blocks, sand containers and so on) that are mounted, possibly guided, at the extremity of an arrangement of levers and pulleys of the machine for the physical exercise.

This load technique for machines for physical exercise presents a series of inconvenients unsolved to date.

First of all the significant weight of the whole machine (when loaded with the ballasts), that constitutes an inconvenient in the home use, where it is often necessary to move the machine. Besides there is a problem of comfort and security, given by the manipulation of the modular ballasts and their load/unload on the machine.

Again, it is impossible to vary the load during the exercise, that means it is impractical to follow the execution of advanced training programs, like those in which the load changes during the exercise or adaptive, like for example a program in which the athlete generates with his muscular strain a fixed power.

The weights—by their same nature—are bounded to work substantially with vertical movements and so they involve constrains in the design of the machines, besides producing considerable burden.

Several methods have been proposed to solve at least partially said inconvenients and they are divided in the following categories: electromagnetic brakes, hydraulic systems, electric motors used as brakes and electromechanical systems coupled with weights.

For example in the U.S. Pat. No. 6,117,049 and U.S. Pat. No. 5,785,632 are disclosed electromechanical methods that are able to control electronically the load that the athlete senses during the exercise by acting on locks on the ballasts. These methods even if they present the advantage of being able to control electronically the load do not resolve the problem of the high weight and encumbrance of the machine.

In the U.S. Pat. No. 5,435,798 is disclosed a method that utilizes an electric motor to control electronically the load. This method, together with others, that utilize standard electric motor, requires however to be coupled with complex apparatus like gears, reducers and transmission clutches in order to transform the rotational movement in linear movement and this causes problems of reliability, encumbrance, cost and difficulty in manufacturing.

In the U.S. Pat. No. 4,063,726 is disclosed an hydraulic method, of the type utilized even in several commercial systems, together with similar others. Such systems however have the defect of being heavy, cumbersome and complex, also they require a constant maintenance, and are subject to problems like the loss of the working fluid.

Finally electromagnetic brakes, proposed in numerous known solutions, present disadvantages analogous to the systems that utilize electric motor because their motion is generally rotational. Moreover their further disadvantage is that they can produce only a force opposite to the movement, that is that they allow only “concentric contraction” of a muscle, and therefore are unsuitable to substitute completely the present weights.

It exists also a German patent DE-3920727 in which is disclosed a load device that utilizes an induction linear motor, that is not provided with permanent magnets, powered by a three-phase alternating current. In general this type of devices does not serve well the purpose, besides it has a low efficiency, a considerable weight and volume and it is not able, like the device of the present invention, to generate electricity.

The patent DE-10351862, grounds on the patent DE-3920727, indicates as defects of it the fact that, in a linear construction, forces in the orthogonal direction of motion arise. These forces can vary the geometry of the construction and can make unstable the apparatus, therefore it is needed to design the apparatus in a solid way, so increasing the weight. The solution that they limit themselves to suggest instead is to use a motor with cylindrical symmetry, that therefore is not affected by unbalanced net forces in radial direction, so that a less solid construction is possible.

The patent EP-1166826, grounds on the German patent DE-3920727, suggests only to utilize the linear motor of DE-3920727 also to help the athlete to carry out an exercise.

In the patent DE-19517090 is described a device that utilize the force that is generated between two cylindrical solenoids or between a solenoid and a permanent magnet. However it is known that said device, because of its geometry, necessitates an high expenditure of energy for its powering in the case that the requested load is comparable to the one that is normally used by an athlete.

In general the patents of the prior art present notable problems such to reduce strongly the range of application in current machines or, like in the case of the patents regarding linear motors, they limit themselves to suggest their use as a load device, without any modification to the prior art, even in a very different field of application and with a very different use. For applications in the fitness field in fact, the simplicity of construction (that means an high symmetry), the compactness, the cheapness, the robustness, and the capacity to develop high and constant loads also in static conditions (that means not in movement), are essential requirements. Obviously the known linear motor are not designed to satisfy all these requirements at the same time.

Therefore it can be affirmed that the methods previously proposed fail to provide a solution to all the inconvenients presented.

### SUMMARY OF THE INVENTION

The aim of the present invention is to provide an electromagnetic load device for a physical apparatus, and a physical apparatus equipped with said device, that resolves completely all the previously explained inconvenients, therefore able to improve noticeably the quality of the training and able to resolve problems like the weight and encumbrance of the current machines, obtaining also an higher safety. The apparatus of the present invention improves the quality of the physical training, by applying a resistive force and not, that it is instantly controllable by the user and by the machine with commands, programs, forces and movements. In the case of home use, the apparatus has a low weight and encumbrance, so it permits to being moved in a simple way. This further advantage means a lower use of materials and lower costs of transportation.

In particular the apparatus object of the present invention is capable to create, control and transmit a force, resistive and not, in a precise and controllable way, enabling the user to utilize our modern knowledge of muscular physiology as well as to decide at a much more detailed level his training program.

Moreover the apparatus presents a weight noticeably lower than the maximum force that is able to generate and a modest electrical consumption, also lower or even negative (that means it can be a net producer of electric energy) when utilized in the way explained in the detailed description.

The mechanism of the present invention gives an alternative to the force produced by machines that utilize gravity, that are the machines currently more diffuse.

One of the principal objective of the present invention is to provide an apparatus that, coupled with training programs studied on purpose that utilize the capacity to change the load in a practically instant manner, is able to improve noticeably the results obtained by the training.

In specific is an objective of the present invention a mechanism and a methodology that achieve an better generation and a better control of the force applied to a machine for physical exercise.

The object of the present invention is an electric linear motor especially developed for a load device for physical exercise utilized for muscles training, including: a couple of permanent magnets, each couple fixed with a plurality of ferromagnetic cores as better described in the following, said couple of permanent magnets place in such a way that adjacent magnets have opposite polarity and opposite magnet are separated by a space and face each other with opposite poles; a plurality of coils of two types as better described in the following place in said space of separation between the permanent magnets and powered by an electric current, said coils being fixed with each other and to a structural support; said permanent magnets and said ferromagnetic cores being included in a mobile part that moves respect to said coils, said mobile part being able to be coupled to a means of connection of said apparatus for the physical exercise.

Moreover is object of the present invention an electromagnetic load device for said apparatus for physical exercise, and an apparatus equipped with said device, as better described in the claims, that forms an integrant part of the present invention.

### SHORT DESCRIPTION OF THE FIGURES

Further scopes and advantages of the present invention will be clear in the detailed description that follows of an example of realization of the same and of their variants and from the included drawings, given in a pure explicative and non limitative way, wherein:

FIG. 1 is a schematic drawing in section that shows the components of an electric linear motor with permanent magnets.

FIG. 2 is a schematic planar view of the coils 3 of a linear motor as in FIG. 1. The coils 3 and a structural support 4 are shown.

FIG. 3 is a planar view from a side that shows a preferred embodiment of a linear motor under the present invention.

FIG. 4 is a planar view from the top of the preferred embodiment of FIG. 3.

FIG. 5 is a view of the section A-A of the preferred embodiment of FIG. 3.

FIG. 6 e FIG. 7 show respectively a view of the coil of the first kind 3′ and of the second kind 3″ of the preferred embodiment of the linear motor under the present invention.

FIG. 8 is a view of the ensemble of coils 3′ e 3″ of FIGS. 6 e 7.

FIG. 9 is a block diagram that schematically shows the electronic control system of the apparatus.

FIG. 10 is a planar view from the top that shows a preferred embodiment of the linear motor under the present invention.

FIG. 11 is a planar view from a side of the preferred embodiment of FIG. 10.

FIG. 12 is a view of section B-B of the preferred embodiment of FIG. 11.

FIG. 13 is a view that shows the preferred embodiment of the assembly of four coils (due 3′ e 3″).

FIG. 14 is a view of section C-C of the preferred embodiment of FIG. 13. The same numbers and the same letters of reference in the figures identify the same elements or components.

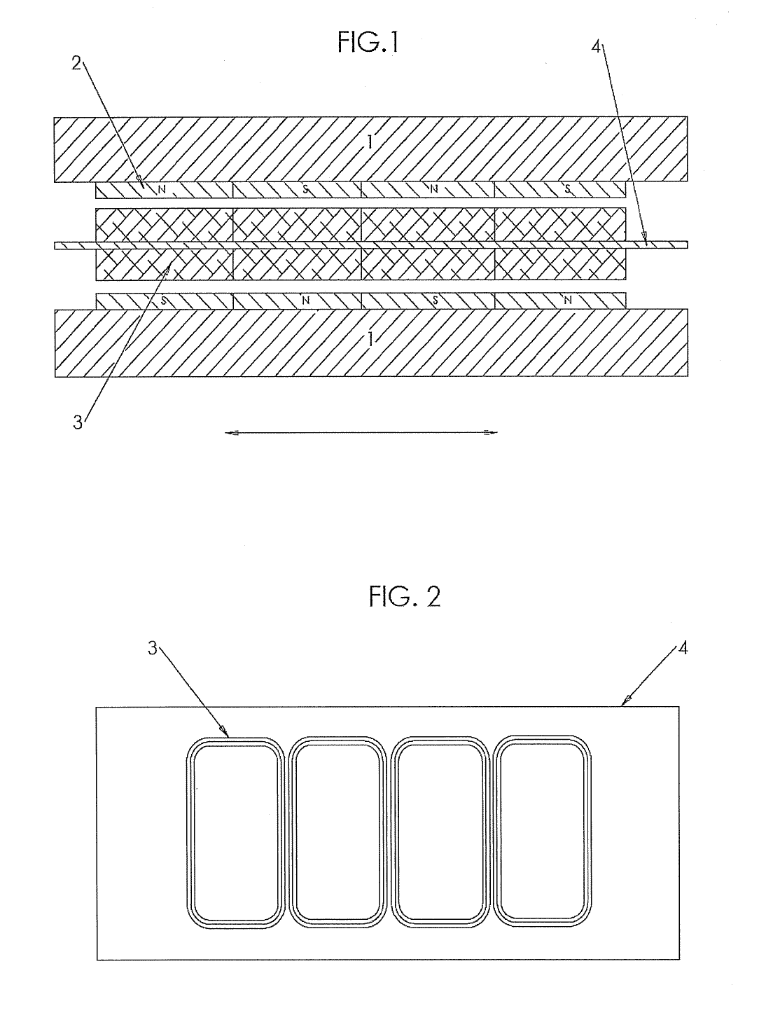

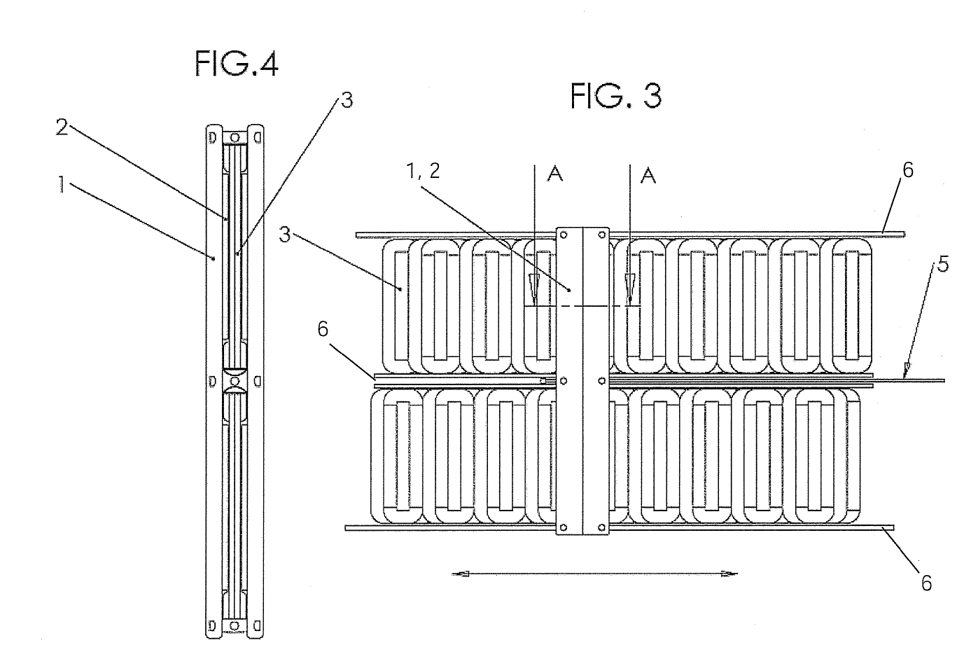

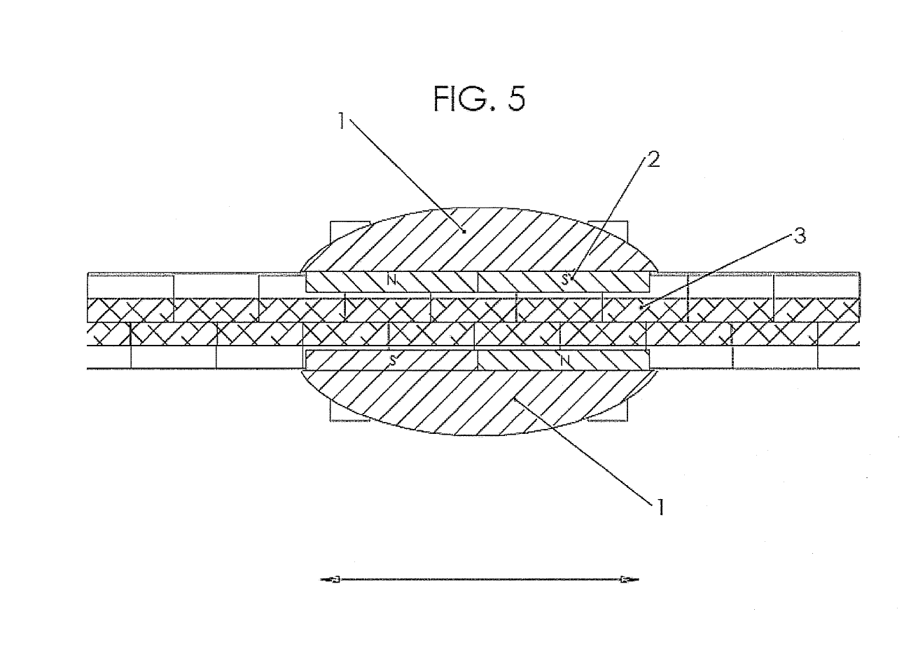

### DETAILED DESCRIPTION WITH EXAMPLES OF PREFERRED EMBODIMENT

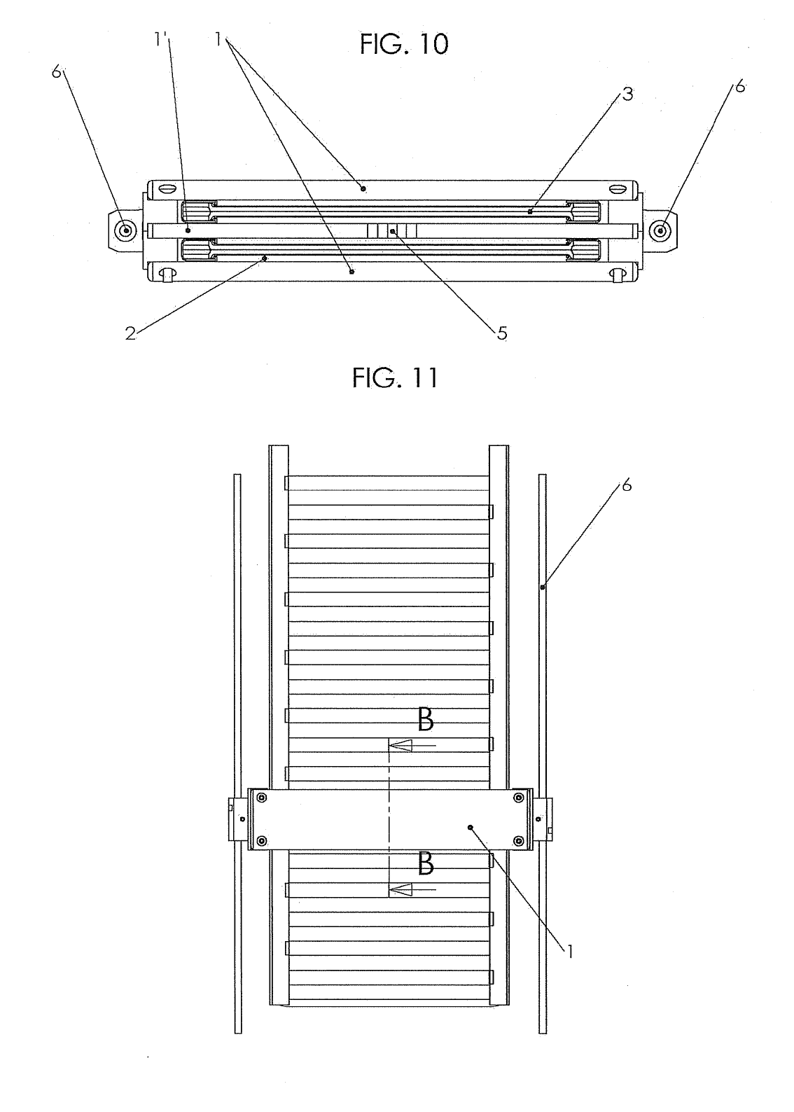

With reference to FIG. 1, are shown the components of a linear electric motor. With reference to the figures, in particular FIG. 3, 4, 5 e FIG. 10, 11, 12, is shown the preferred embodiment of the linear electric motor that generates the force, being part of the load device under the present invention. In the first embodiment the two groups of coils are placed side by side, in the second are superimposed on two parallel planes.

In the figures are highlighted the ferromagnetic cores 1, the permanent magnets 2, the coils 3 of conductive material powered by an electric current and a structural support 4 for the coils 3 of a material of high thermal conductivity. Moreover is presented a means to be connected mechanically 5 to the desired exercise machine of a known type.

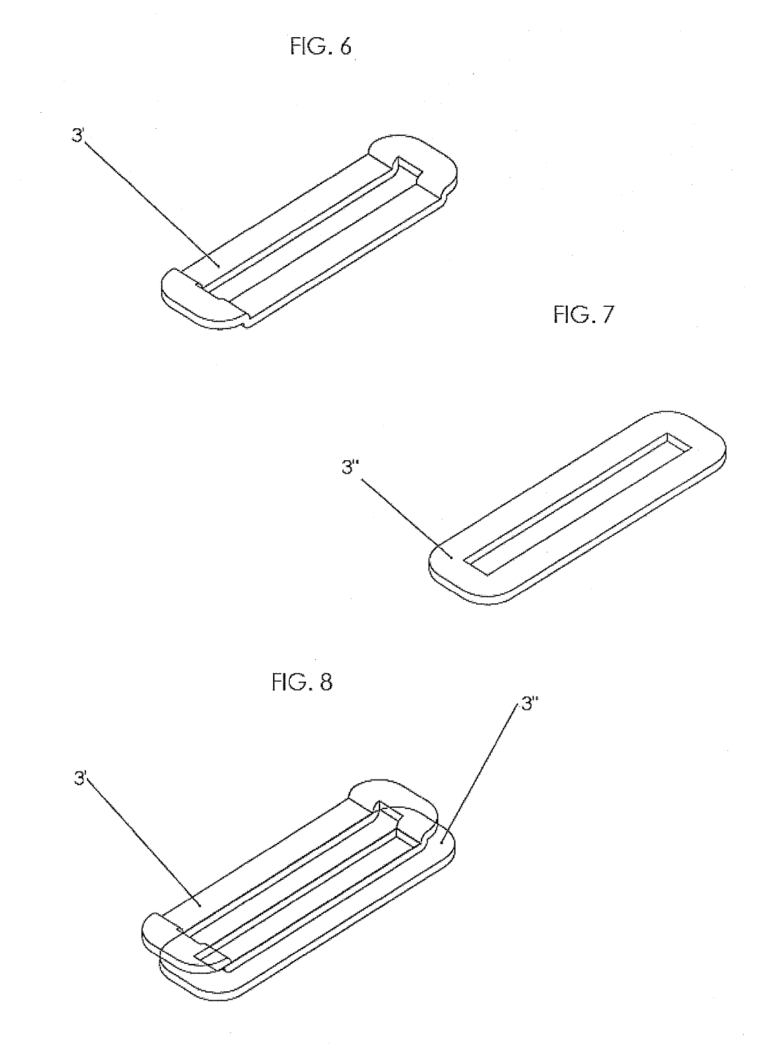

In particular in FIG. 6, 7, 8, 13, 14 is shown in detail a preferred embodiment of the coils 3.

The system that produces the load sustained by the athlete, also called linear electric motor, is composed of a plurality of magnets 2, such that adjacent magnets have opposite polarity and opposite magnets are separated by a space and face each other with opposite poles, fixed, for example with epoxy, to a plurality of ferromagnetic cores 1 and in said space of separation between the magnets are placed the coils 3 powered by an electric current, which in turn are fixed to each other or to a structural support 4 made from a material with an high thermal conductivity.

The ferromagnetic cores 1 can be made with one of the known ferromagnetic materials like for example pure iron, mild steel, carbon steel, silicon steel, magnetic stainless steel, mild ferrite, nickel and iron alloys such as Permalloy, nickel, iron and cobalt alloys such as Kovar. Among them are preferred in particular carbon steel and silicon steel alloys for their high saturation and low cost.

On the preferred embodiment in FIG. 5 the ferromagnetic cores 1 have a shape similar to that of a half an ellipse and have an high enough thickness in order to contain most of the magnetic flux thereto. On the flat part is fixed, for example with epoxy resins, a couple of permanent magnets 2 with opposite polarities, with lower length compared to the cores, in order to leave a space to position the coils 3′ e 3″. In the case of the preferred embodiment of FIG. 10 is presented, besides the ferromagnetic cores 1, also a flat nucleus 1′, to which the magnets are fixed in the same way as with the cores 1, placed in the movable central part of the apparatus and fixed to it, and it provided with the means for connection 5 to the apparatus of known type.

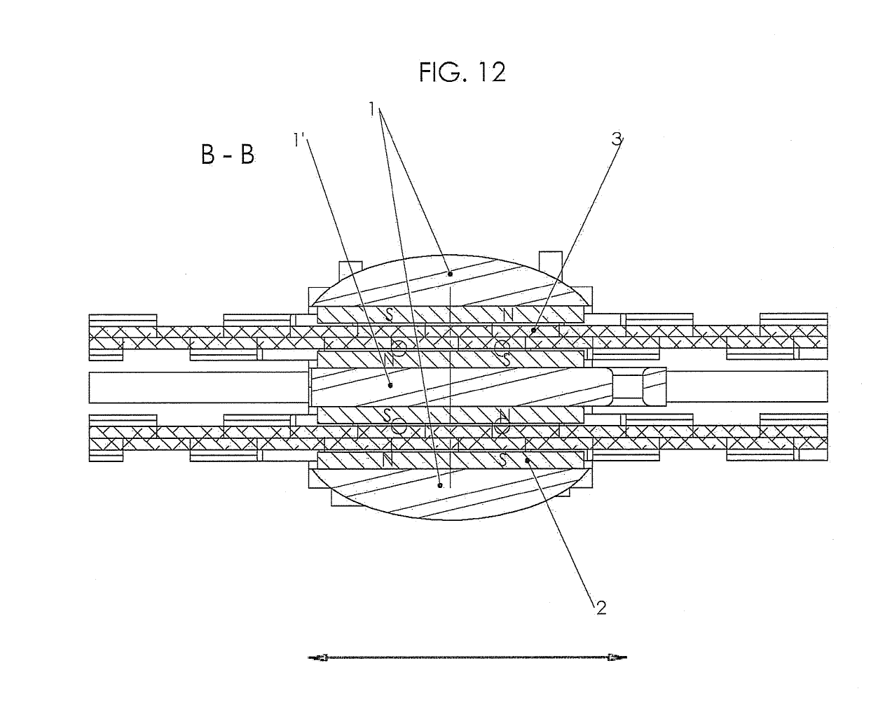

The permanent magnets 2 can be made from one of the known materials used to fabricate permanent magnets like rare earth, ferrite, and Alnico. Among them are preferred in particular rare earth magnets like the Nd—Fe—B coated, to prevent the oxidation, for example with Ni. As it is shown in FIG. 5 e FIG. 12 the permanent magnets of the preferred embodiment are wide about two times the side width of the coils.

The coils 3 can be made with one of the known materials that are good electrical and thermal conductors like for example aluminum and copper. Among them is preferred in particular the aluminum because it combines good electrical and thermal characteristics with a low specific weight.

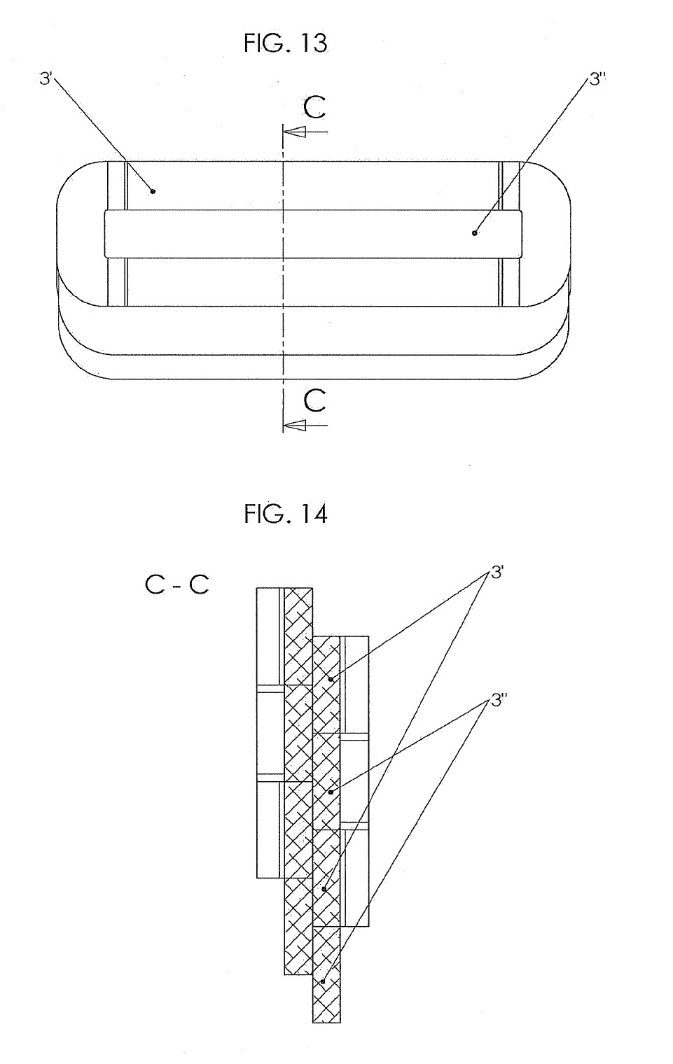

In particular in FIGS. 8, 13 and 14 it is shown a preferred method to assembly the two different kinds of coils 3′ and 3″ shown in FIG. 6 e FIG. 7.

The two different kinds of coils present themselves a flat and elongated shape; the first type 3′ presents its two short sides raised. The assembly is carried out by putting side by side in an alternated way the two types of coils: the long side of the coils 3′ fits in the central aperture of the coils 3″, so they result placed in the same plane, by taking advantage of the raised short side of the coils 3′.

As it is shown in detail of the section of FIG. 5, 10, 13 e 14, the ensemble of the coils 3 in one of the preferred embodiment is composed by two rows of coils 3 placed as it is shown in FIG. 8. Each row presents two layer of coils. The layers are attached to each other shifted by a distance equal to half the width of the side of the coils. As it appears the total set-up is particularly compact and efficient. The structural support 4 of the coils 3 can be done with one of the known materials that are both good thermal conductors and poor electrical conductors, with the aim to reduce parasitic currents, like for example certain alloys of aluminum, certain ceramics, etc.

The connection to the apparatus for muscles strengthening of the known type happens through the means for connection 5 as it is shown in FIG. 3 and in FIG. 10.

When the permanent magnets 2 are found over the coils 3 on which a current flows in the direction given by the geometry of the coils, they are subject to a force in the longitudinal direction as indicated by the direction of the arrow in FIG. 3, 5 and in FIG. 12. Therefore the assembly composed by the ferromagnetic cores 1 and the magnets 2 is able to translate in the longitudinal direction over the coils 3, for example by using guides 6. The means for connection 5, for example a cable, is fixed with the assembly and translates with it.

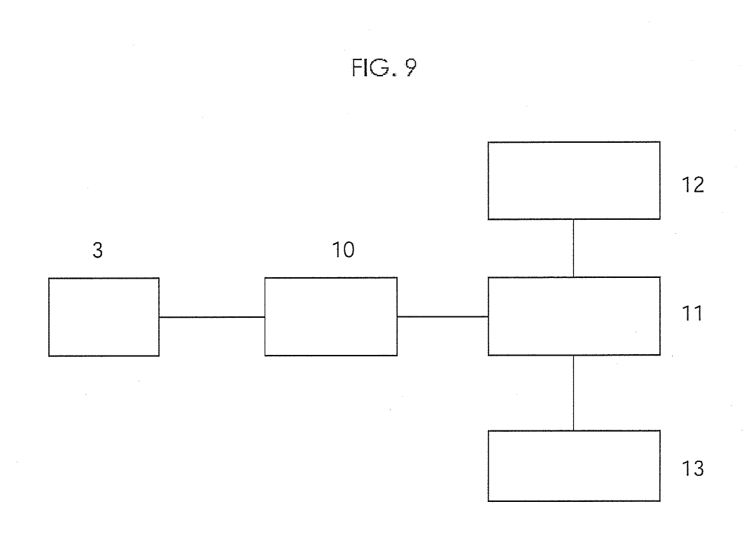

The coils 3 are powered in sequence during the movements of the permanent magnets 2 and the direction of current in the changes, under the commands of the microcontroller, in order to produce a force in the desired direction. The control of the intensity of the force takes place by modifying the current that circulate on the coils 3. As it is shown in FIG. 9 the power control system of the coils 3 is composed by a power supply 10, commanded by the microcontroller 11 and provided with its own internal memory for example solid state or magnetic, and connected electrically with a series of sensors 12 that are divided in: dynamic sensors that measure position, velocity and movement; general diagnostic sensors that measure for example the temperature of the coils 3; physiological sensors like for example heart rate sensors, body temperature, etc.

In a very short period of time the sensors 12 produce useful signals for the microcontroller 11 in order to adjust the current on the coils 3 under the preferences of the athlete, set through the control user interface 13, connected to the microcontroller and commanded by the user (the athlete), provided with a display, commands and supports for external memories.

With the aim to minimize the power absorption of the apparatus, the microcontroller 11 powers the coils 3 that are found immediately between, entirely or in part, the permanent magnets 2. In particular, depending on the position, the microcontroller chooses the current level for each coils 3 that are found immediately between, entirely or in part, the permanent magnets 2 in a way that the same force is produced dissipating the lowest possible amount of power.

It is evident that the group of coils are coupled relatively shifted by a length equal to half the width of one side of the coils, and that the couple of permanent magnets 2 is fixed to the semielliptical ferromagnetic cores 1 or flat 1′.

To better comprehend the mechanism to control the power it is useful a discussion of a simple mathematical model of the situation. Let say iₖ is the current flowing on the k-th coil 3 and let fₖ be the coefficient function of the relative position of the k-th coil 3 respect to the permanent magnets 2 (in substance a coefficient proportional to the integral of the magnetic field on the volume of the coil), such that we can write the relationship:

F∝Σₖfₖiₖ

where F is the generated force.

The power dissipated in the coil 3 has the expression:

P∝Σiₖ²

This quantity can be simply minimized and it can be obtained that the values of the currents iₖ have to be proportional to the coefficients fₖ. This control method can be simply implemented via software or through dedicated hardware.

Besides the apparatus, in certain operating conditions, is able to dissipate less power of what it would be necessary to produce a certain force and also to become a net producer of energy.

In fact as it is known to an expert in the field the variation of the magnetic flux through each coil 3 produced by the movement of the permanent magnets 2 on the opposite direction to the force produced by the machine (that is when the muscles of the athlete carry out concentric movements) produce a back-electromagnetic force that in turn produce a current in the same direction of the current that already flows in the coils 3, making possible to reduce the current intensity that it is necessary to supply to obtain a certain force and therefore to reduce the power draw in by the apparatus. From this it descends that for a range of forces and velocities (as it is known the back-electromagnetic force is proportional to the velocity) the apparatus has the ability, when concentric movements are carried out, to generate electricity.

This energy can be used to power the electronics of the apparatus, alternatively it can be stored or returned to the grid. For example it is convenient that this range corresponds to the way of exercising for normal people.

The system can be enclosed in a wrapper with the aim to isolate the movable parts of the apparatus and to provide a shield to the low frequency electromagnetic field produced by the machine. The shield can be composed for example by one or more layers of materials with high susceptibility of the known type commonly used for shielding purpose as for example pure iron, mild steel, carbon steel, silicon steel, magnetic stainless steel, mild ferrite, nickel and iron alloys such as Permalloy, nickel, iron and cobalt alloys such as Kovar.

The advantages that result from the application of the present invention are clear. The linear motor, that is the apparatus that generates the force, answers within times of the order of milliseconds to the commands ordered by the microcontroller through the power supply. The microcontroller, provided with an internal memory where the software for the operation of the machine and several programs are stored, constantly monitors the various dynamical sensors that measure for example the position, velocity and movement of the machine and the physiological sensors like for example the hearth rate, body temperature, etc., and regulates the force depending on the training program (that can use all the informations given by the physiological sensors) that the user has chosen through the interface, among the predefined programs or loaded from the external memory (for example from a USB support).

In particular the mechanism of the present invention has the following capabilities:
a) Capability to instantly regulate the force. The linear motor of the present invention is driven by a microcontroller that controls in a fast and precise way the current that flows inside the coils 3, achieving an instantaneous capacity to regulate the force.
b) Instantaneous measure of the velocity. The microcontroller, through the sensors connected to it, is capable to instantly measure the velocity of execution of the exercise.
c) Ability to work isotonically. The apparatus and the methodology have the capacity to keep the force constant as the velocity changes and more in general can execute whatever desired force profile as the velocity changes.
d) Ability to work isokinetically. The apparatus and the methodology have the capacity to keep the velocity constant as the force changes and more in general can execute whatever desired velocity profile as the force changes.
e) Ability to work isotonically/isokinetically. The apparatus and the methodology allow to choose whatever combination of isotonic/isokinetic work through its program.
f) Ability to work with concentric and eccentric movements. The present invention is able to work either when the muscle shortens (concentric movement) and lengthens (eccentric movement).
g) Ability to work isotonically with concentric movements/isokinetically with eccentric movements. The apparatus and the methodology are able to control the cinematic and dynamic variables of the exercise such that they allow to work in a isotonic manner when the muscle shortens (concentric movement) and in an isokinetic manner when the muscle lengthens (eccentric movement).

The load device of the present invention therefore is able to substitute the standard ballasts used in the physical exercise machine of the known type. A considerable reduction of the weight and encumbrance of a machine equipped with the present invention in comparison with a machine equipped with a standard load of ballasts is possible. This further facilitates the adoption of the present invention in particular in the home fitness sector so as to permit the athlete to benefit from a machine provided with the indicated numerous functionalities and capable to improve in a sensible way the quality of their training.

The preferred embodiment of the present invention is to be considered with a pure illustrative scope. It is not to be considered exhaustive or as a limit of the invention in the precise form specified in it. Many variations and modification are possible in light of the present teaching. It is understood that the invention is not limited by the detailed discussion specified in it but from the following claims.

It is understood that the mechanism of the present invention can be utilized on every type of machine for physical exercise that actually use a load of weights.

1. Linear electric motor especially for a load device for an apparatus for physical exercise for muscle training, comprising:
a plurality of permanent magnets (2), fixed to a plurality of ferromagnetic cores (1), said plurality of permanent magnets being such that the adjacent magnets have opposite polarities and the opposite magnets are separated by a space and are facing each other with opposite poles;
a plurality of coils (3) positioned in said separation space between the permanent magnets (2) and supplied by an electrical power supply, said coils being fixed to one another or to a structural support; said permanent magnets (2) and said ferromagnetic cores (1) being comprised in a movable part which slides with respect to said coils, said movable part being suitable to be coupled to a means (5) for connection to said apparatus for physical exercise.

2. Electric motor as claimed in claim 1, wherein said plurality of coils (3) comprises coils of the first (3′) and a second (3″) type, of flat and elongated toroidal shape, said first type of coil (3′) presenting two raised short sides, and being assembled with said second type of coils (3″) placing the two types of coils alternately side by side, so that the long sides of the coils of the first type (3′) slot into the central slots of the coils of the second type (3″).

3. Electric motor as claimed in claim 2, wherein said plurality of coils (3) is arranged in two groups placed side by side on the same plane and with the means for connection (5) placed between the two groups.

4. Electric motor as claimed in claim 2, wherein said plurality of coils (3) is arranged in two groups superimposed in two parallel planes, wherein said two planes being interposed at least one further ferromagnetic nucleus (1′) fixed to said mobile part.

5. Electric motor as claimed in claim 2, wherein said assemblies of coils are arranged in groups relatively moved for a length equal to half the width of a side of the coils.

6. Electric motor as claimed in claim 1, wherein a couple of permanent magnets (2) is fixed to semielliptical ferromagnetic cores(1) or flat (1′).

7. Electric motor as claimed in claim 1, wherein when said permanent magnets (2) are located over said coils (3), in which a current flows in the direction given by the direction of the windings, they are subject to a force in a longitudinal direction, such that the assembly composed of ferromagnetic core (1) and permanent magnets (2) is capable of moving in said longitudinal direction over the coils, said coils being supplied in sequence during movement of the permanent magnets, the direction of the current therein changing so as to produce a force in the desired longitudinal direction, the extent of said force being controllable through the value of the current circulating in the coils.

8. Electric motor as claimed in claim 1, wherein the construction material of said ferromagnetic cores (1) comprises pure iron, or mild iron, or carbon steel, or silicon steel, or magnetic stainless steel, or mild ferrite, or nickel and iron alloys such as Permalloy, nickel, iron and cobalt alloys such as Kovar.

9. Electric motor as claimed in claim 1, wherein the construction material of said permanent magnets (2) comprises rare earth, or ferrite or Alnico.

10. Electric motor as claimed in claim 1, wherein the construction material of said coils (3) comprises aluminum or copper.

11. Electric motor as claimed in claim 1, wherein said structural support is composed of a material with high thermal conductivity.

12. (canceled)

13. Load device as claimed in claim 1, also comprising:
an electrical power supply connected to the coils of the linear motor to supply said current thereto;
at least one micro controller electrically connected to the power supply;
a series of sensors, comprising dynamic and control sensors of the device, electrically connected to the controller;
a user interface electrically connected with the microcontroller.

14. Load device as claimed in claim 13, wherein said series of sensors comprise position, velocity, movement, temperature and physiological sensors that monitor the physical condition of the athlete such as heart beat and temperature sensors.

15. Load device as claimed in claim 13, wherein said power supply comprises devices to store the electrical energy produced and/or devices to feed electrical energy into the networks and/or devices for self-powering the apparatus.
